(19) United States
(12) Patent Application Publication
(10) Pub. No.: US 2011/0264364 A1
(43) Pub. Date: Oct. 27, 2011

(54) NAVIGATION DEVICE FOR A VEHICLE

(75) Inventor: Thorsten Herchenroeder, Ruesselsheim (DE)

(73) Assignee: GM GLOBAL TECHNOLOGY OPERATIONS LLC, Detroit, MI (US)

(21) Appl. No.: 13/094,555

(22) Filed: Apr. 26, 2011

(30) Foreign Application Priority Data
Apr. 27, 2010 (DE) 102010018334.2

(51) Int. Cl. G01C 21/00

(52) U.S. Cl. 701/200

(57) ABSTRACT

A navigation device is provided for a vehicle with a processing unit for calculating the journey time of the vehicle for a planned route, wherein the calculating of the journey time takes place taking into consideration the vehicle configuration selected from several different selectable configurations of the vehicle.

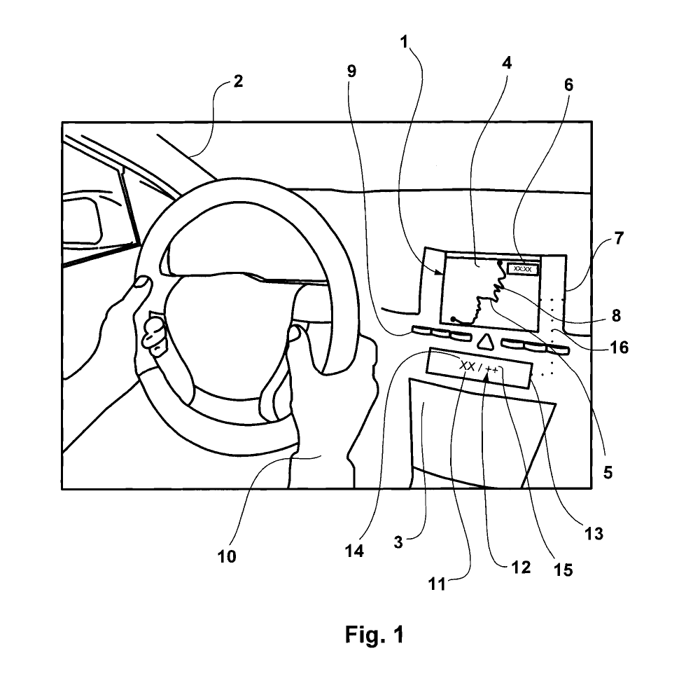

### CROSS-REFERENCE TO RELATED APPLICATION

This application claims priority to German Patent Application No. 102010018334.2, filed Apr. 27, 2010, which is incorporated herein by reference in its entirety.

### TECHNICAL FIELD

The technical field relates to a navigation device, which serves exclusively or in addition to further functions for the calculation, display and/or recommendation of a route between at least two distant locations or geographical points for a vehicle. Navigation devices of this type are frequently also designated as navigation systems in general linguistic usage. The term route is to be understood within the present invention to mean the path which is travelled by a vehicle, e.g., from location A to location B. Intersections, junctions and courses of the road can be taken into account here, which must be used by the vehicle in order to reach the destination.

### BACKGROUND

A navigation device can be seen from the US patent application with the published document US 2009/0271109 A1. This navigation device can be operated in various modes, e.g., in a pedestrian mode, a vehicle mode or a seafaring mode. A switchover between the various modes brings about a change to the map representation on a display unit of the navigation device. In addition, the calculation of a route takes place as a function of the various modes. This navigation device does indeed enable a usage in very different types of locomotion, e.g., for pedestrians and drivers of road or water vehicles, but in its functionality and ability to determine a route, it remains bound to the respectively selected type of locomotion.

Against this background, at least one object is to provide a navigation device with an optimized prognosis of the journey time and/or of the time of arrival at the destination of the calculated route. In addition, other objects, desirable features and characteristics will become apparent from the subsequent summary and detailed description, and the appended claims, taken in conjunction with the accompanying drawings and this background.

### SUMMARY

A navigation device for a vehicle according to an embodiment comprises a processing unit for calculating the journey time of the vehicle for a planned route. The calculation of the journey time takes place taking into consideration the vehicle configuration selected from several different selectable configurations of the vehicle.

An advantage is the improved accuracy of the calculated or predicted journey time of the vehicle for the planned route. The processing unit can calculate the journey time for example depending on which operating mode of the vehicle is currently selected. For example, the selection of an operating mode by which a comparatively uninterrupted manner of driving is to be expected leads, according to the invention, to a reduced calculated or predicted journey time, e.g., compared with the roadway-dependent standard average speeds used in conventional navigation systems. By comparison, selected operating modes, by which a comparatively slow manner of driving is to be expected, lead according to the invention to a greater calculated or predicted journey time of the vehicle compared with conventional standard average speeds.

The taking into account of the currently selected vehicle configuration can take place, for example, in that the processing unit recognizes automatically which operating mode is currently set or selected by the vehicle driver. For this, for example data concerning the motor control or operating parameters of the vehicle can be evaluated, which characterize the selected operating mode. The predicted journey time and/or the calculated or predicted arrival time can be displayed on a display unit in the vehicle. The vehicle driver can, for example, read the calculated journey time of the planned route from the display unit. As required, the vehicle driver can select various configurations on a trial basis, then read the corresponding change to the calculated journey times brought about by this, and thus gain a sense of the effect of the selected configuration on the duration of the journey to be expected, and the arrival time.

In an embodiment of the invention, the processing unit is acted upon with information concerning the currently selected vehicle configuration by means of coupling with a selector unit for the configuration of the vehicle. This direct coupling of the navigation device with information concerning the current vehicle configuration makes possible a direct and automatic matching of the determination of the journey time e.g. to the selected operating mode.

According to another embodiment, the processing unit bases the determining of the journey time with selection of a sport mode configuration on a higher average speed, so that a reduced journey time results. Through this embodiment, a more uninterrupted manner of driving is taken into consideration, which is to be expected by the selection of a sport mode. As a rule, in the sport mode a manner of driving at an increased average speed is namely to be expected. The reduced journey time resulting from this can be determined directly by the processing unit and can give the vehicle driver, via the display unit, a sense of the altered manner of driving by the selection of the sport mode.

According to another embodiment, with the selection of an economical configuration, e.g., in a so-called eco mode, the processing unit bases the determining of the journey time on a lower average speed, so that an increased journey time results. Through this embodiment, the manner of driving, e.g., to be expected on selection of the eco mode, with reduced average speeds, is taken into consideration by the navigation device. The increased journey time resulting from this can be indicated directly to the vehicle driver and can given him a sense of the altered manner of driving to be expected by the selection of an economical mode.

### BRIEF DESCRIPTION OF THE DRAWINGS

The present invention will hereinafter be described in conjunction with the following drawing figure showing a navigation device according to an embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

The figure shows a navigation device 1, which is integrated into a vehicle instrument fitting 3 arranged in a vehicle 2. The navigation device 1 comprises a display unit 4, which presents information for example concerning a planned route 5 or concerning a journey time 6 for the planned route 5. In addition, the navigation device 1 has a processing unit 7 which, in a manner known per se and therefore not explained further here, calculates both the course 8 of the planned route 5 and also the journey time 6.

By means of an operating element 9 in the vehicle instrument fitting 3, the vehicle driver 10 can select a desired actual vehicle configuration from a number of selectable configurations of the vehicle 2. In the example embodiment, the selectable vehicle configurations consist of several different operating modes 11, from which an operating mode 12 is able to be selected. A further display unit 13 indicates the various selectable operating modes 11 and the currently selected operating mode 12.

On selecting a sport mode 14, the processing unit 7 is acted upon by corresponding information and bases the calculation of the journey time 6 on an increased average speed of the vehicle, compared with a standard value. This increase can be determined empirically in advance or else in the simplest case can constitute a simple, e.g. percentage addition. Therefore, in the sport mode 14, the display unit 4 indicates a comparatively reduced journey time 6 and correspondingly an earlier arrival time.

On selecting an eco mode 15, the processing unit 7 is acted upon by corresponding information and bases the calculation of the journey time 6 on a reduced average speed of the vehicle compared with the sport mode and/or with a standard value. This adaptation here, therefore, the reduction of the speed forming the basis can also be determined empirically in advance. Accordingly, the display unit 4 in the eco mode 15 indicates a comparatively greater journey time 6 and correspondingly a later arrival time.

The processing unit 7 is connected with the operating modes 11 via a direct coupling 16, so that a selecting of an operating mode 12 takes place to a direct adaptation of the journey time 6 to the manner of driving which is to be expected by the selecting of the operating mode. Alternatively, the current vehicle configuration could, however, also be obtained by the provision or evaluation of vehicle parameters, e.g., dates of the motor control and conveyed to the processing unit 7.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A navigation device for a vehicle, comprising:
a memory configured to store a plurality of selectable configurations of the vehicle; and
a processing unit configured to calculate a journey time of the vehicle for a planned route,
where the processing unit is configured to calculate the journey time based at least in part on a currently selected configuration of the plurality of selectable configurations of the vehicle.

2. The navigation device according to claim 1, further comprising a selector unit configured to provide the processing unit with the currently selected configuration.

3. The navigation device according to claim 1, wherein the currently selected configuration is a sport mode configuration.

4. The navigation device according to claim 3, wherein the processing unit is configured to calculate the journey time based at least in part on a higher average speed if the currently selected configuration is the sport mode configuration.

5. The navigation device according to claim 1, wherein the currently selected configuration is an economical configuration.

6. The navigation device according to claim 5, wherein the processing unit is configured to calculate the journey time based at least in part on a lower average speed if the currently selected configuration is the economical configuration.
